(19) United States
(12) Patent Application Publication
(10) Pub. No.: US 2026/0308080 A1
(43) Pub. Date: Oct. 8, 2026

(54) IGNITION FORMULATION

(71) Applicant: Raindance Systems Pty Ltd, Canning Vale (AU)

(72) Inventor: Robert Andrew Stevenson, Canning Vale (AU)

(21) Appl. No.: 19/481,512

(22) PCT Filed: May 8, 2024
(86) PCT No.: PCT/AU2024/050446

§ 371 Date: Nov. 4, 2025

(30) Foreign Application Priority Data
May 8, 2023 (AU) 2023901379

(51) Int. Cl. C06C 15/00; A62C 3/02; C06C 9/00

(52) U.S. Cl. CPC C06C 15/00; A62C 3/0285; C06C 9/00

(57) ABSTRACT

Disclosed is an ignition formulation for use as an aerial ignition incendiary. The ignition formulation comprises an incendiary material and an ignition fluid. The ignition fluid includes an alcohol-based reactant capable of reacting exothermically with the incendiary material to an extent sufficient to generate a flame. The ignition fluid also includes an alcohol-based suppressant capable of delaying a time needed to generate the flame upon contact of the alcohol-based reactant with the incendiary material compared to a time required to generate the flame in an absence of the alcohol-based suppressant.

### FIELD

The present disclosure relates to an incendiary used as an aerial ignition source, for example for backburning processes.

### BACKGROUND

The present Applicant has developed numerous incendiary capsules and machines for airborne dispensing of incendiary capsules. Examples of these are described in Australian patent No. 2003204999, 2011223497, and 2011293093. The incendiary material used in each instance comprises at least potassium permanganate. The potassium permanganate is held within a capsule. The capsules are subsequently injected with an initiator in the form of a glycol using an automated dispensing machine and subsequently dropped to the ground. The dispensing machine can be mounted in or on an aircraft so that the capsules once injected with the initiator are dropped from the aircraft to fall to the ground.

The potassium permanganate and initiator react exothermically to produce a flame. Efficacy is maximised if the flame is generated when the capsule is on the ground rather than in the air. To exert some control over the period of time between initial injection of the initiator and the production of a flame, third parties have been known to mix glycol with water. This slows the exothermic reaction providing sufficient time for the capsule to reach the ground prior to the generation of the flame. Injection of a mixture of water and glycol into a capsule of potassium permanganate has however been known to cause the capsule to explode due to the generation of steam prior to the generation of a flame. Moreover, the presence of water may quench the flame or at least reduce flame size. The amount of water added may also need to be adjusted depending on ambient temperatures, adding complexity and potential user error.

The above references to background art do not constitute an admission that the art forms a part of the common general knowledge of a person of ordinary skill in the art. The above references are also not intended to limit the application of the formulation, system and methods as disclosed herein.

### SUMMARY

An embodiment provides an ignition formulation for use as an aerial ignition incendiary, comprising:
an incendiary material;
an ignition fluid comprising:
   an alcohol-based reactant capable of reacting exothermically with the incendiary material to an extent sufficient to generate a flame; and
   an alcohol-based suppressant capable of delaying a time needed to generate the flame upon contact of the alcohol-based reactant with the incendiary material compared to a time required to generate the flame in the absence of the alcohol-based suppressant.

Throughout this disclosure the term “delay” or “delaying a time” may be used interchangeably with the term “dwell” or “dwell time” to describe how the alcohol-based suppressant increases a time required to generate a flame upon contact of the ignition fluid with the incendiary material.

The skilled addressee would recognise that the alcohol-based suppressant may act to inhibit, minimise or reduce the reactiveness of the alcohol-based reactant.

The time required to generate the flame upon contact of the ignition fluid with the incendiary material may range from about 25 seconds to about 60 seconds. A flashpoint of the ignition fluid may be at least 65° C. The alcohol-based reactant may be a primary alcohol. The alcohol-based reactant may be mono-ethylene glycol. The alcohol-based suppressant may be a primary alcohol. The alcohol-based suppressant may be 1-pentanol. The alcohol-based suppressant may be benzyl alcohol. The alcohol-based suppressant may be a mixture of two or more primary alcohols. The alcohol-based suppressant may include a mixture of 1-pentanol and benzyl alcohol. A ratio (vol %) of 1-pentanol to benzyl alcohol may range from 1:10 to 10:1. A ratio (vol %) of 1-pentanol to benzyl alcohol may range from 1:2 to 2:1. A ratio (vol %) of 1-pentanol to benzyl alcohol may be approximately 1:2. The ignition fluid may have a ratio (vol %) of alcohol-based reactant to alcohol-based suppressant ranging from 75:25 to 40:60.

A ratio (w/v %) of the incendiary material to a volume of the ignition fluid may range from about 90:10 to about 80:20. The ignition formulation may be free from solvents, co-solvents and/or surfactants. A reaction between the alcohol-based suppressant and incendiary material may be less exothermic than the reaction between the alcohol-based reactant and the incendiary material.

The incendiary material may be a metal oxidising agent. The oxidising agent may include a salt of permanganate (MnO₄²⁻), chromate (CrO₄²⁻), dichromate (Cr₂O₇²⁻), or cobalt oxide (Co₂O₃). The oxidising agent may be potassium permanganate. The alcohol-based suppressant may be consumable by the generated flame.

An embodiment provides an ignition formulation for use as an aerial ignition incendiary, comprising:
potassium permanganate as an incendiary material;
an ignition fluid comprising a 70:20:10 (vol %) mixture of mono-ethylene glycol, benzyl alcohol and 1-pentanol;
wherein a ratio of the potassium permanganate and ignition fluid ranges from 90:10 to 80:20 such that the mono-ethylene glycol can react exothermically upon contact with the potassium permanganate to an extent sufficient to generate a flame and the benzyl alcohol and 1-pentanol delay a time needed to generate the flame upon contact of the mono-ethylene glycol with the potassium permanganate compared to a time required to generate the flame in an absence of the benzyl alcohol and 1-pentanol.

The incendiary material may be housed in a combustible container and the ignition fluid may be addable to incendiary material housed in the combustible container. For example, a needle pay pierce the combustible container to inject the ignition fluid therein.

An embodiment provides an ignition system for use as an aerial ignition incendiary, comprising:
Part A comprising an incendiary material; and
Part B comprising an ignition fluid comprising:
   an alcohol-based reactant capable of reacting exothermically with the incendiary material to an extent sufficient to generate a flame; and
   an alcohol-based suppressant capable of delaying a time required to generate the flame upon contact of the alcohol-based reactant with the incendiary material compared to a time required to generate the flame in the absence of the alcohol-based suppressant.

An embodiment provides a kit for an ignition system for use as an aerial ignition incendiary, comprising:
Part A comprising an incendiary material; and
Part B comprising an ignition fluid comprising:
   an alcohol-based reactant capable of reacting exothermically with the incendiary material to an extent sufficient to generate a flame; and
   an alcohol-based suppressant capable of delaying a time required to generate the flame upon contact of the alcohol-based reactant with the incendiary material compared to a time required to generate the flame in the absence of the alcohol-based suppressant.

The ignition formulation, alcohol-based reactant and an alcohol-based suppressant of the system and/or kit may be as set forth above.

An embodiment provides an ignition system for use as an aerial ignition incendiary, the ignition system comprising:
a capsule body containing an incendiary material, and
an ignition reservoir housing an ignition fluid and configured to inject the ignition fluid into the capsule body, the ignition fluid may be as set forth above.

An embodiment provides a method of controlling the generation of a flame from an incendiary capsule comprising a quantity of incendiary material sealed in a capsule body, the method comprising:
injecting the ignition fluid as set forth above into the capsule body thereby causing a delay period between contact of the ignition fluid with the incendiary material and generation of the flame.

The method may further comprise dispensing one or more of the capsule bodies injected with the ignition fluid from an air-borne vehicle to an area of land in need of controlled burning. The method may further comprise dispensing one or more of the capsule bodies injected with the ignition fluid from a land vehicle or from a ground-based operator to an area of land in need of controlled burning. The method may further comprise dispensing one or more of the capsule bodies injected with the ignition fluid from a water-borne vehicle to an area of land in need of controlled burning.

### DETAILED DESCRIPTION

A dwell time or delay of ignition time for the exothermic reaction between the incendiary material and the reactant that causes an exothermic reaction sufficient to generate a flame is one of the main parameters of an aerial ignition incendiary. For example, an activated incendiary (i.e. one where the reactant has contacted the incendiary material) needs to safely exit an aircraft and drop through a forest canopy or standing fuel and then settle amongst the ground fuel before igniting. The US Forest service has mandated a compulsory 20 second minimum delay before ignition for all incendiaries dropped.

Some incendiaries require the addition of water to increase a dwell or delay time. However, the amount of water required is dependent on the ambient temperature. Accordingly, the dwell time in the absence of water is tested in pre-flight test, then water is added to the ignition fluid until a desired dwell time is achieved. This then necessitates additional tests to check compliance. This situation is onerous, complex and time consuming when on occasion time is of the essence for wildfire back burning. The addition of water also reduces desirable flame characteristics such as flame temperature and height.

An embodiment may provide an ignition formulation for use as an aerial ignition incendiary that has a reliable 20+ second ignition delay time for all incendiary material (e.g. KMNO₄) particle size and particle size distribution, particle purity and ambient temperature differences across a wide range of latitudes and temperatures. In an embodiment, it may be desirable if the delay time is less than one minute during cold weather so that the ignitions and ongoing fuel burn can be confirmed in a reasonable time frame. Prior art ignition formulations tend to ignite too quickly in hot conditions and too slowly in cold conditions.

An embodiment provides an ignition formulation for use as an aerial ignition incendiary. The ignition formulation may be used in an air-borne vehicle, a land vehicle or from a ground-based operator, and/or water-borne vehicle, to an area of land in need of controlled burning. The formulation includes an incendiary material and an ignition fluid. Contacting the incendiary material with the ignition fluid causes an exothermic reaction sufficient to generate a flame. The flame may consume the incendiary material and ignition fluid. The flame may consume the alcohol-based suppressant. The ignition fluid may be free from water or other aqueous-based suppressants.

The ignition fluid includes an alcohol-based reactant capable of reacting exothermically with the incendiary material to an extent sufficient to generate a flame. The ignition fluid also includes an alcohol-based suppressant. The alcohol-based suppressant can delay a time needed to generate the flame upon contact of the alcohol-based reactant with the incendiary material compared to a time required to generate the flame in the absence of the alcohol-based suppressant.

Although the suppressant helps to delay an ignition time from contact of the injection fluid with the incendiary material, it may also help to improve flame characteristics. For example, addition of the alcohol-based suppressant may help to increase a flame temperature closer to 1000° C. compared to a flame temperature in the absence of the alcohol-based suppressant. Having a higher flame temperature may help to improve ignition rates of combustible material such as undergrowth and leaf litter during backburning operations. A higher flame temperature may also help to ensure complete combustion of the incendiary material, the ignition fluid, and any container or capsule that houses the incendiary material.

In an embodiment, the incendiary material is housed in a combustible container and the ignition fluid can be added to the incendiary material housed in the combustible container. The combustible container may be formed from plastic. The plastic may be ABS. A needle or equivalent may pierce the combustible container to deliver the ignition fluid to an interior volume of the combustible container that houses the incendiary material.

The time required to generate the flame depends on the ambient temperature in which the incendiary material is contacted with the ignition fluid. For example, in cooler temperatures, the time required to generate the flame may be longer compared with warmer temperatures. The time required to generate the flame upon contact of the ignition fluid with the incendiary material may range from about 20 seconds to about 120 seconds. The time required to generate the flame upon contact of the ignition fluid with the incendiary material may range from about 20 seconds to about 100 seconds. The time required to generate the flame upon contact of the ignition fluid with the incendiary material may range from about 20 seconds to about 80 seconds. The time required to generate the flame upon contact of the ignition fluid with the incendiary material may range from about 20 seconds to about 60 seconds. The time required to generate the flame upon contact of the ignition fluid with the incendiary material may range from about 25 seconds to about 60 seconds. The time required to generate the flame upon contact of the ignition fluid with the incendiary material may range from about 25 seconds to about 45 seconds. The above ranges of time may shift up or down depending on ambient temperatures. In an embodiment, the time required to generate the flame upon contact of the ignition fluid with the incendiary material may be from 25 seconds to 60 seconds in all temperatures with an undiluted ignition fluid.

In an embodiment, a reaction between the alcohol-based suppressant and incendiary material is less exothermic than the reaction between the alcohol-based reactant and the incendiary material. Put another way, the alcohol-based suppressant may still react with the incendiary material to cause an exothermic reaction to generate a flame, but the rate of reaction of the alcohol-based suppressant with the incendiary material may be lower than the rate of reaction of the alcohol-based reactant with the incendiary material. Accordingly, the alcohol-based suppressant may suppress a rate of reaction of the alcohol-based reactant and the incendiary.

The alcohol-based reactant may be a primary alcohol. For example, the primary alcohol may include methanol, ethanol, propanol, butanol, pentanol, hexanol, heptanol and/or octanol. The primary alcohol may be a diol. The alcohol-based reactant may be a glycol species. The glycol species may be ethylene glycol. In an embodiment, the alcohol-based reactant is mono-ethylene glycol.

The alcohol-based suppressant may be a primary alcohol. For example, the primary alcohol may include methanol, ethanol, propanol, butanol, pentanol, hexanol, heptanol and/or octanol. In an embodiment, the alcohol-based suppressant is 1-pentanol. The primary alcohol may be an R group on another species. For example, the primary alcohol may be benzyl alcohol.

The ignition fluid includes the alcohol-based reactant and alcohol-based suppressant. A ratio (vol %) of alcohol-based reactant to alcohol-based suppressant may range from 99:1 to 40:60. A ratio (vol %) of alcohol-based reactant to alcohol-based suppressant may range from 95:5 to 40:60. A ratio (vol %) of alcohol-based reactant to alcohol-based suppressant may range from 90:10 to 40:60. A ratio (vol %) of alcohol-based reactant to alcohol-based suppressant may range from 85:15 to 40:60. A ratio (vol %) of alcohol-based reactant to alcohol-based suppressant may range from 80:20 to 40:60. A ratio (vol %) of alcohol-based reactant to alcohol-based suppressant may range from 75:25 to 40:60. A ratio (vol %) of alcohol-based reactant to alcohol-based suppressant may be approximately 70:30.

When the alcohol-based suppressant is 1-pentanol, a ratio (vol %) of alcohol-based reactant to alcohol-based suppressant may range from 85:15 to 40:60, such as 70:30 to 40:60. When the alcohol-based suppressant is benzyl alcohol, a ratio (vol %) of alcohol-based reactant to alcohol-based suppressant may range from 75:25 to 50:50. When the alcohol-based suppressant is 1-pentanol, a ratio (vol %) of alcohol-based reactant to alcohol-based suppressant may be 65:35. The alcohol-based suppressant may include a mixture of alcohols such as a mixture of primary alcohols. Using a mixture of alcohols for the alcohol-based suppressant can help to fine tune ignition and flame characterises. For example, the alcohol-based suppressant may include a mixture of 1-pentanol and benzyl alcohol. A ratio (vol %) of 1-pentanol to benzyl alcohol may range from 1:10 to 10:1, such as about 1:5 to 5:1, or 1:2 to 2:1. In an embodiment, a ratio (vol %) of 1-pentanol to benzyl alcohol is approximately 1:2. The addition of 1-pentanol and/or benzyl alcohol (i.e. primary alcohols) to mono-ethylene glycol also helped to act as a cleaner and remove the stickiness of glycol in pumps and hoses associated with an ignition fluid delivery system. This can help to removing the need to flush the system at the end of operations.

A ratio (w/V %) of the incendiary material to a volume of the ignition fluid may range from about 90:10 to about 80:20.

The alcohol-based suppressant may be consumed by the generated flame. Consumption or combustion of the alcohol-based suppressant may help to improve flame properties and reduce or eliminate residue after combustion.

The ignition formulation may be free from solvents, co-solvents, diluents and/or surfactants. Being free from solvents, co-solvents and/or surfactants can help to improve the reproducibility of the formulation is use when generating a flame for ignition purposes. It may also help to improve shelf life of the ignition fluid. For example, the ignition fluid may have a shelf life of at least 6 months.

A flash point of the ignition fluid may be at least 65° C. A flashpoint of the ignition fluid may be such that the ignition fluid is not classified as a dangerous good. A higher flashpoint may also help to reduce the risk of unexpected ignition, such as during use in hot climates. As an example, if the alcohol-based reactant is mono ethylene glycol with a flashpoint of 111° C. and the alcohol-based suppressant is 1-pentanol with a flashpoint of 32.7° C., a mixture of 65% mono ethylene glycol and 35% 1-pentanol may have a flashpoint of about 83° C.

The incendiary material may be a metal oxidising agent. The oxidising agent may include a salt of permanganate (MnO₄⁻), chromate (CrO₄²⁻), dichromate (Cr₂O₇²⁻), or cobalt oxide (Co₂O₃). In an embodiment, the oxidising agent is potassium permanganate.

In an embodiment, the ignition formulation comprises:
potassium permanganate as an incendiary material;
an ignition fluid comprising a 70:20:10 (vol %) mixture of mono-ethylene glycol, benzyl alcohol and 1-pentanol;
wherein a ratio of the potassium permanganate and ignition fluid ranges from 90:10 to 80:20 such that the mono-ethylene glycol can react exothermically upon contact with the potassium permanganate to an extent sufficient to generate a flame and the benzyl alcohol and 1-pentanol delay a time needed to generate the flame upon contact of the mono-ethylene glycol with the potassium permanganate compared to a time required to generate the flame in an absence of the benzyl alcohol and 1-pentanol.

The inventor found that an alcohol-based suppressant offers several advantages over using water to increase a dwell time of the ignition formulation. For example, the alcohol-based suppressant can include a mixture of different alcohols, where the mixture is selected to fine tune the dwell time.

An embodiment provides an ignition system for use as an aerial ignition incendiary, comprising:
Part A comprising an incendiary material; and
Part B comprising an ignition fluid comprising:
   an alcohol-based reactant capable of reacting exothermically with the incendiary material to an extent sufficient to generate a flame; and
   an alcohol-based suppressant capable of delaying a time required to generate the flame upon contact of the alcohol-based reactant with the incendiary material compared to a time required to generate the flame in the absence of the alcohol-based suppressant.

An embodiment provides a kit for ignition system for use as an aerial ignition incendiary, comprising:
Part A comprising an incendiary material; and
Part B comprising an ignition fluid comprising:
   an alcohol-based reactant capable of reacting exothermically with the incendiary material to an extent sufficient to generate a flame; and
   an alcohol-based suppressant capable of delaying a time required to generate the flame upon contact of the alcohol-based reactant with the incendiary material compared to a time required to generate the flame in the absence of the alcohol-based suppressant.

The alcohol-based reactant and an alcohol-based suppressant may be as set forth above.

An embodiment provides an ignition system for use as an aerial ignition incendiary. The ignition system comprises a capsule body containing an incendiary material, and an ignition reservoir housing an ignition fluid and configured to inject the ignition fluid into the capsule body. The ignition fluid may be as set forth above.

An embodiment also provides a method of controlling the generation of a flame from an incendiary capsule comprising a quantity of incendiary material sealed in a capsule body. The method may comprise injecting the ignition fluid as set forth above into the capsule body thereby causing a delay period between contact of the ignition fluid with the incendiary material and generation of the flame.

The method may further comprise dispensing one or more of the capsule bodies injected with the ignition fluid from an air-borne vehicle to an area of land in need of controlled burning. The method may further comprise dispensing one or more of the capsule bodies injected with the ignition fluid from a land vehicle or from a ground-based operator to an area of land in need of controlled burning. The method may further comprise dispensing one or more of the capsule bodies injected with the ignition fluid from a water-borne vehicle to an area of land in need of controlled burning.

### EXAMPLES

Exemplary embodiments of an ignition formulation for controlling the generation of a flame from an incendiary material will now be described.

### 1-Pentanol as Suppressant

A capsule formed from ABS was loaded with 1.4 g of potassium permanganate and sealed with a plastic film. 0.2 mL of an ignition fluid was then injected into the capsule at ambient temperatures (~22° C.). Injection was the start time to record the dwell time or delay needed to generate the flame upon contact of the alcohol-based reactant with the incendiary material. The ignition fluid included mono-ethylene glycol (MEG) as the alcohol-based reactant and 1-pentanol as the alcohol-based suppressant. Note that when the ambient temperature was hot (38° C.), the delay was 15 seconds for an ignition fluid having 100% mono ethylene glycol.

The volume of ignition fluid injected into the capsule with potassium permanganate was varied from between 0.15 mL to 0.25 mL. During testing it was found that 0.2 mL of ignition fluid injected into the capsule with 1.4 g of potassium permanganate provided the best result for initial flame flare, ongoing burn, white hot flame measured to almost 1000° C. and complete combustion of the ABS capsule. The best mix ratio for all round performance was found to be 65% MEG and 35% 1-pentanol. When the ignition fluid had 65% MEG and 35% 1-pentanol, the ignition delay was found to be 28 seconds when the ambient temperature was about 38° C., and 55 seconds when the ambient temperature was about 16° C.

The delay or dwell time along with associated flame characteristics for an injection fluid having mono ethylene glycol and various amounts of 1-pentanol as the alcohol-based suppressant and contacted with potassium permanganate is outlined in Table 1.

TABLE 1
Delay and flame characteristics for ignition fluid composition
with varying amounts of 1-pentanol and mono-ethylene glycol
(MEG) when contacted with potassium permanganate.

| MEG | 1-pentanol | Delay time* | |
|---|---|---|---|
| (vol %) | (vol %) | (seconds) | Flame performance |
| 100 | 0 | 35 | Unchanged |
| 95 | 5 | 35 | Unchanged |
| 90 | 10 | 37 | Unchanged |
| 85 | 15 | 38 | Better |
| 80 | 20 | 41 | Better |
| 75 | 25 | 42 | Better |
| 70 | 30 | 43 | Better |
| 65 | 35 | 46 | Best |
| 60 | 40 | 55 | Best |
| 55 | 45 | 68 | Best |
| 50 | 50 | 80 | Best |
| 45 | 55 | 94 | Best |
| 40 | 60 | 108 | Best |
| 35 | 65 | 120 | Inconsistent ignition |
| 30 | 70 | — | Smoke only; failed to burn |
| 25 | 75 | — | No reaction |
| 20 | 80 | — | No reaction |
| 15 | 85 | — | No reaction |

*22° C. ambient temperature with 1.4 g KMnO₄ and 0.2 mL of ignition fluid.

### Benzyl Alcohol as Suppressant

A capsule formed from ABS was loaded with 1.4 g of potassium permanganate and sealed with a plastic film. 0.2 mL of an ignition fluid was then injected into the capsule at ambient temperatures (~22° C.). Injection was the start time to record the dwell time or delay needed to generate the flame upon contact of the alcohol-based reactant with the incendiary material. The ignition fluid included mono-ethylene glycol (MEG) as the alcohol-based reactant and benzyl alcohol as the alcohol-based suppressant. Note that when the ambient temperature was hot (38° C.), the delay was 15 seconds for 100% mono ethylene glycol.

The volume of ignition fluid injected into the capsule with potassium permanganate was varied from between 0.15 mL to 2.25 mL. During testing it was found that 0.2 mL of ignition fluid injected into the capsule with potassium permanganate provided the best result for initial flame flare, ongoing burn, white hot flame measured to almost 1000° C. and complete combustion of the ABS capsule.

The delay or dwell time along with associated flame characteristics for an injection fluid having mono ethylene glycol and various amounts of benzyl alcohol as the alcohol-based suppressant is outlined in Table 2. When more than 25% benzyl alcohol was added to the MEG the dwell time raised significantly but was also inconsistent. The addition of benzyl alcohol added greater performance compared with 1-pentanol in relation to increased temperature and flame.

TABLE 2
Delay and flame characteristics for ignition fluid composition
with varying amounts of benzyl alcohol to mono-ethylene
glycol (MEG) when contacted with potassium permanganate.

| MEG | Benzyl alcohol | Delay time* | |
|---|---|---|---|
| (vol %) | (vol %) | (seconds) | Flame performance |
| 100 | 0 | 41 | Unchanged |
| 90 | 10 | 41 | Unchanged |
| 80 | 20 | 41 | Unchanged |
| 75 | 25 | 45 | Better |
| 70 | 30 | 48 | Better |
| 60 | 40 | 65 | Best |
| 50 | 50 | 78 | Best |
| 40 | 60 | — | No ignition, only smoke |
| 30 | 70 | — | No ignition, only smoke |
| 20 | 80 | — | No ignition, only smoke |
| 10 | 90 | — | No ignition, only smoke |

*22° C. ambient temperature with 1.4 g KMnO₄ and 0.2 mL of ignition fluid.

### Mixture of Benzyl Alcohol and 1-Propanol as Suppressant

A capsule formed from ABS was loaded with 1.4 g of potassium permanganate and sealed with a plastic film. 0.2 mL of an ignition fluid was then injected into the capsule at ambient temperatures (~22° C.). Injection was the start time to record the dwell time or delay needed to generate the flame upon contact of the alcohol-based reactant with the incendiary material. The ignition fluid included mono-ethylene glycol (MEG) as the alcohol-based reactant and a mixture of benzyl alcohol and 1-propanol as the alcohol-based suppressant. Note that when the ambient temperature was hot (38° C.), the delay was 15 seconds for 100% mono ethylene glycol.

The volume of ignition fluid injected into the capsule with potassium permanganate was varied from between 0.15 mL to 2.25 mL. During testing it was found that 0.2 mL of ignition fluid injected into the capsule with potassium permanganate provided the best result for initial flame flare, ongoing burn, white hot flame measured to almost 1000° C. and complete combustion of the ABS capsule.

The delay or dwell time along with associated flame characteristics for an injection fluid having 70% (vol %) mono ethylene glycol and various amounts of benzyl alcohol and 1-propanol as the alcohol-based suppressant is outlined in Table 3. It was unexpectedly found that addition of 1-pentanol to benzyl alcohol helped to improve more consistent delay time while improving flame performance such as temperature.

TABLE 3
Delay and flame characteristics for ignition fluid composition
with having 70% (vol %) mono ethylene glycol (MEG)
and various amounts of benzyl alcohol and 1-propanol
when contacted with potassium permanganate.

| MEG | Benzyl alcohol | 1-Pentanol | Delay time* | Flame |
|---|---|---|---|---|
| (vol %) | (vol %) | (vol %) | (seconds) | performance |
| 70 | 0 | 30 | 43 | Better |
| 70 | 5 | 25 | 43 | Better |
| 70 | 10 | 20 | 44 | Better |
| 70 | 15 | 15 | 45 | Best |
| 70 | 20 | 10 | 48 | Best |
| 70 | 25 | 5 | 48 | Best |
| 70 | 30 | 0 | 48 | Less consistent |

*22° C. ambient temperature with 1.4 g KMnO₄ and 0.2 mL of ignition fluid.

In the claims that follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

Modifications and variations as would be apparent to a skilled addressee are deemed to be within the scope of the present invention.

1. An ignition formulation for use as an aerial ignition incendiary, the formulation comprising:
an incendiary material; and
an ignition fluid comprising:
an alcohol-based reactant capable of reacting exothermically with the incendiary material to an extent sufficient to generate a flame; and
an alcohol-based suppressant capable of delaying a time needed to generate the flame upon contact of the alcohol-based reactant with the incendiary material compared to a time required to generate the flame in an absence of the alcohol-based suppressant;
wherein the formulation is free from solvents, co-solvents and/or surfactants.

2. An ignition formulation as claimed in claim 1, wherein the time required to generate the flame upon contact of the ignition fluid with the incendiary material ranges from about 25 seconds to about 60 seconds.

3. An ignition formulation as claimed in claim 1, wherein a flashpoint of the ignition fluid is at least 65° C.

4. An ignition formulation as claimed in claim 1, wherein the alcohol-based reactant is a primary alcohol.

5. (canceled)

6. An ignition formulation as claimed in claim 1, wherein the alcohol-based suppressant is a primary alcohol.

7. (canceled)

8. An ignition formulation as claimed in claim 6, wherein the alcohol-based suppressant includes a mixture of 1-pentanol and/or benzyl alcohol and a ratio (vol %) of 1-pentanol to benzyl alcohol ranges from 1:10 to 10:1.

9. An ignition formulation as claimed in claim 8, wherein a ratio (vol %) of 1-pentanol to benzyl alcohol ranges from 1:2 to 2:1.

10. (canceled)

11. An ignition formulation as claimed in claim 1, wherein the ignition fluid has a ratio (vol %) of alcohol-based reactant to alcohol-based suppressant ranging from 75:25 to 40:60.

12. An ignition formulation as claimed in claim 1, wherein a ratio (w/v %) of the incendiary material to a volume of the ignition fluid ranges from about 90:10 to about 80:20.

13. An ignition formulation as claimed in claim 1, wherein a reaction between the alcohol-based suppressant and incendiary material is less exothermic than the reaction between the alcohol-based reactant and the incendiary material.

14. An ignition formulation as claimed in claim 1, wherein the incendiary material is a metal oxidising agent.

15. An ignition formulation as claimed in claim 14, wherein the metal oxidising agent includes a salt of permanganate (MnO₄⁻), chromate (CrO₄²⁻), dichromate (Cr₂O₇²⁻), or cobalt oxide (Co₂O₃).

16. An ignition formulation as claimed in claim 15, wherein the metal oxidising agent is potassium permanganate.

17. An ignition formulation as claimed in claim 1, wherein the alcohol-based suppressant can be consumed by the generated flame.

18. An ignition formulation for use as an aerial ignition incendiary, the formulation comprising:
potassium permanganate as an incendiary material; and
an ignition fluid comprising a 70:20:10 (vol %) mixture of mono-ethylene glycol, benzyl alcohol and 1-pentanol;
wherein a ratio of the potassium permanganate and ignition fluid ranges from 90:10 to 80:20 such that the mono-ethylene glycol can react exothermically upon contact with the potassium permanganate to an extent sufficient to generate a flame and the benzyl alcohol and 1-pentanol delay a time needed to generate the flame upon contact of the mono-ethylene glycol with the potassium permanganate compared to a time required to generate the flame in an absence of the benzyl alcohol and 1-pentanol,
wherein the ignition formulation is free from solvents, co-solvents and/or surfactants.

19. An ignition formulation as claimed in claim 18, wherein the incendiary material is housed in a combustible container and the ignition fluid can be added to the incendiary material housed in the combustible container.

20. An ignition system for use as an aerial ignition incendiary, the system comprising:
Part A comprising an incendiary material; and
Part B comprising an ignition fluid comprising:
an alcohol-based reactant capable of reacting exothermically with the incendiary material to an extent sufficient to generate a flame; and
an alcohol-based suppressant capable of delaying a time required to generate the flame upon contact of the alcohol-based reactant with the incendiary material compared to a time required to generate the flame in an absence of the alcohol-based suppressant,
wherein Part B is free from solvents, co-solvents and/or surfactants.

21. (canceled)

22. A kit for an ignition system for use as an aerial ignition incendiary, the kit comprising:
Part A comprising an incendiary material; and
Part B comprising an ignition fluid comprising:
an alcohol-based reactant capable of reacting exothermically with the incendiary material to an extent sufficient to generate a flame; and
an alcohol-based suppressant capable of delaying a time required to generate the flame upon contact of the alcohol-based reactant with the incendiary material compared to a time required to generate the flame in an absence of the alcohol-based suppressant,
wherein Part B is free from solvents, co-solvents and/or surfactants.

23. (canceled)

24. (canceled)

25. (canceled)

26. (canceled)

27. (canceled)

28. (canceled)

29. An ignition formulation as claimed in claim 1, wherein the incendiary material is housed in a combustible container and the ignition fluid can be added to the incendiary material housed in the combustible container.
